(19) United States
(12) Patent Application Publication
(10) Pub. No.: US 2023/0294841 A1
(43) Pub. Date: Sep. 21, 2023

(54) GROUND SUPPORT EQUIPMENT

(71) Applicant: ILLINOIS TOOL WORKS INC., Glenview, IL (US)

(72) Inventors: Bo Vork NIELSEN, Faborg (DK); Søren Risgaard DAHL, Rudkøbing (DK)

(73) Assignee: ILLINOIS TOOL WORKS INC., Glenview, IL (US)

(21) Appl. No.: 18/122,969

(22) Filed: Mar. 17, 2023

(30) Foreign Application Priority Data
Mar. 18, 2022 (EP) 22163071.8

(51) Int. Cl. B64F 1/36; H02J 7/00; H02J 7/02; B60L 53/60; B60L 53/53

(52) U.S. Cl. CPC B64F 1/362; H02J 7/00712; H02J 7/02; B60L 53/60; B60L 53/53; H02J 2207/20; B60L 2200/00

(57) ABSTRACT

Ground support equipment for powering an aircraft on the ground, the ground support equipment including: a solid state converter configured to power an aircraft on the ground from an airport power source having a pre-determined maximum power, and a battery charging unit configured to charge an external battery from the airport power source. The solid state converter is configured to measure an instantaneous power drawn by the aircraft. The solid state converter is configured to generate, for controlling the battery charging unit, a control signal indicative of a maximum power available for the battery charging unit based on the difference between the pre-determined maximum power of the airport power source and the instantaneous power drawn by the aircraft.

### CROSS-REFERENCE TO RELATED APPLICATION

European Patent Application No. EP 22 16 3071.8, filed 18 Mar. 2022, the priority document corresponding to this invention, to which a foreign priority benefit is claimed under Title 35, United States Code, Section 119, and its entire teachings are incorporated, by reference, into this specification.

### BACKGROUND OF THE INVENTION

### Field of the Invention

This invention relates to a ground support equipment. In particular, the present invention relates to a ground support equipment for powering an aircraft on the ground.

### Discussion of Related Art

Airports have ground support equipment, such as ground power units, for powering aircraft when parked next to an airport building. This ground-based power supply allows the electronic systems of the aircraft to remain on without needing the aircraft engines to be running which would require additional aviation fuel.

Airports also have a number of powered and non-powered equipment on the tarmac which provide various functions. Powered equipment such as refuelers, tugs, eGPUs and buses, are required periodically throughout the day to move fuel, aircraft and passengers. However, one barrier to wider adoption of electrifying these vehicles is a lack of battery charging capacity at airports.

The present invention seeks to address at least some of these issues.

### SUMMARY OF THE INVENTION

Viewed from a first aspect, the present invention provides a ground support equipment for powering an aircraft on the ground, the ground support equipment comprising: a solid state converter configured to power an aircraft on the ground from an airport power source having a pre-determined maximum power, and a battery charging unit configured to charge an external battery from the airport power source. The solid state converter is configured to measure an instantaneous power drawn by the aircraft. The solid state converter is configured to generate, for controlling the battery charging unit, a control signal indicative of a maximum power available for the battery charging unit based on the difference between the pre-determined maximum power of the airport power source and the instantaneous power drawn by the aircraft.

Thus, the present invention provides a ground support equipment which can function as a ground power unit for powering an aircraft on the ground and divert any excess power to a charging port for charging a battery of an electric vehicle at the same time. Thus, the battery of different ground handling equipment or vehicles can be charged when the aircraft does not require the maximum power from the ground support equipment, or when the aircraft does not need powering, such as at night or when no aircraft is present at the gate. As the solid state converter includes a controller for monitoring the power drawn by the aircraft, the present invention does away with the need for additional power controllers to determine how much power can be diverted to the charging port. A further advantage of the present ground support equipment is to utilize the same, either a new or existing, airport power source to power the aircraft's equipment as well as mobile battery powered equipment close to where they are used. This is in contrast to providing double the power infrastructure to power the charging port which would add significant costs to the airport.

The solid state converter controller and the battery charging unit controller may be operatively connected to one another. This provides a communication channel between the solid state converter controller and the battery charging unit controller so that the battery charging unit controller can receive the control signal from the solid state converter controller. The battery charging unit can therefore provide power to the charging port in a manner that is limited based on the power drawn by the aircraft and based on the known maximum power output of the airport power supply. As the airport power supply has a known power output (i.e. the maximum power output for the airport power supply is pre-determined or pre-set for the airport), the ground support equipment can be pre-set or pre-programmed or manually set to work with the known airport power supply. As such, the present ground support equipment does not have a separate transducer to measure the total power being drawn by the ground support equipment to determine how much power can be drawn by the battery charging unit.

The solid state converter may be configured to receive a user input for setting the pre-determined maximum power. Thus, a ground operator can easily set or adjust the pre-determined maximum power level at the gate based on the requirements of the aircraft and/or based on the known output of the airport power supply.

The control signal may be based on the difference between the pre-determined maximum power level and the current power level drawn by the aircraft. In some cases, the power to the battery charging unit is reduced as power to the aircraft is required. This advantageously reduces the risk of any components being overloaded when there is a high power demand of the aircraft.

The battery charging unit may comprise a plurality of power modules configured to receive power from the airport power source. The plurality of power charging modules may be connected in parallel.

At least one of the plurality of power charging modules may be configured to provide a 30 kW output.

At least one of the plurality of charging modules is configured to convert an AC input to a DC output. The battery charging unit may be configured to provide a DC power output. In some cases, the DC power output is a high voltage output.

The ground support equipment may comprise a common rectifier configured to convert an AC input to a DX output. This advantageously provides a DC bus which can be used to power the battery charging unit and any other components of the ground support equipment, such as the solid state converter for powering the aircraft. The DC bus may be configured to provide power to each of the plurality of power charging modules.

The solid state converter may be configured to provide a 400 Hz output. The solid state converter may be configured to receive power from an AC power source. The solid state converter may be configured to provide up to 180 kW output power. The solid state converter may be pre-fused.

The battery charging unit may be configured to provide an output power of 120 kW. The battery charging unit may be configured to provide a DC power output.

The ground support equipment may comprise a plurality of solid state converters configured to provide power to the aircraft. The plurality of solid state converters may be connected in parallel.

### BRIEF DESCRIPTION OF SEVERAL VIEWS OF THE DRAWINGS

Embodiments of the invention are further described hereinafter with reference to the accompanying drawings, in which:

FIG. 1 illustrates a first side of an exemplary ground support equipment;

FIG. 2 illustrates a cross-sectional view of the first side illustrated in FIG. 1;

FIG. 3 illustrates a second side of the ground support equipment of FIG. 1;

FIG. 4 illustrates a cross-sectional view of the second side illustrated in FIG. 3;

FIG. 5 shows a schematic illustration of an exemplary electrical circuit according to one embodiment;

FIG. 6 shows a schematic illustration of an exemplary electrical circuit according to one embodiment;

FIG. 7 shows a schematic illustration of an exemplary electrical circuit according to one embodiment;

FIG. 8 shows a schematic illustration of an exemplary electrical circuit according to one embodiment; and

FIG. 9 shows a schematic illustration of an exemplary electrical circuit according to one embodiment.

### DESCRIPTION OF PREFERRED EMBODIMENTS

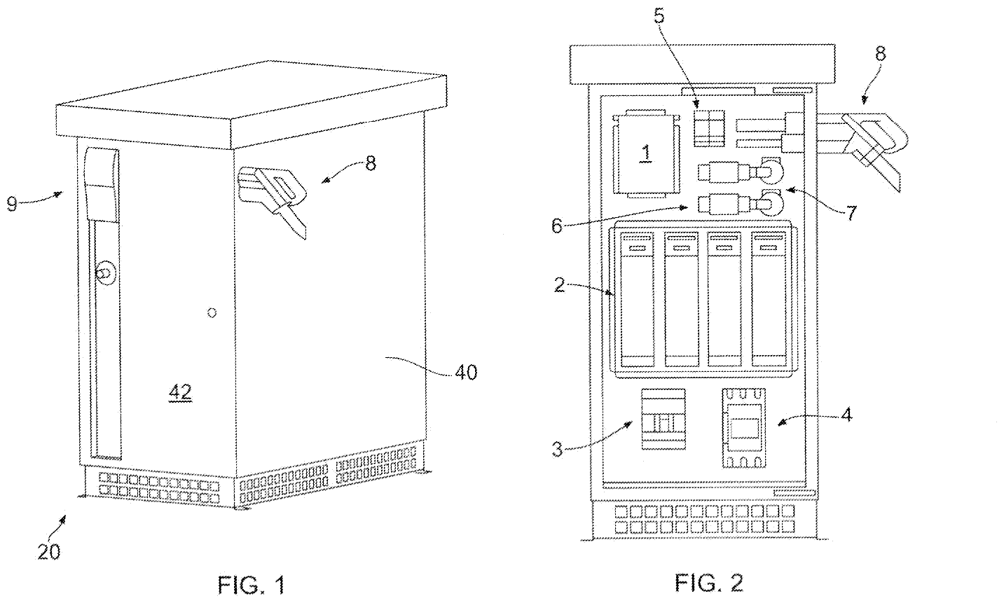

An exemplary ground support equipment 20 is shown in FIG. 1. The ground support equipment 20 will typically be installed as a fixed unit on the ground close to where an aircraft will be parked on the ground.

The ground support equipment 20 has a cabinet 40 having a first side 42 of the ground support equipment includes a user interface 9 for a charging port shown in FIG. 1 connected to a CCS2 connector 8. By way of example, only a single charging port is shown, but it would be apparent that more than one charging port could be provided in each ground support equipment 20. The charging port may be configured to connect to a CCS2 connector as shown in FIGS. 1 to 4 or to a CHAdeMO connector. The CCS2 and CHAdeMO connectors are both able to provide DC charging. It would be apparent that these were merely exemplary connectors and that other connectors could be suitable for use with the present ground support equipment.

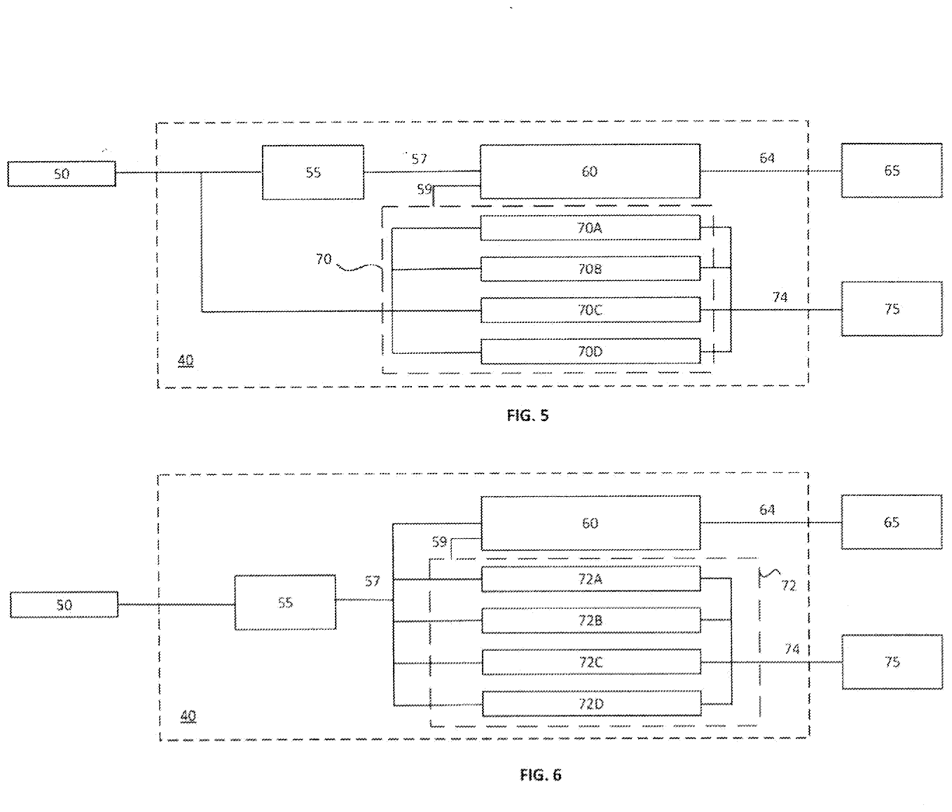

FIG. 2 illustrates a panel of the first side 42 removed to show an exemplary electrical circuit of a charging unit which provides the battery charging functionality described herein. A charger control unit 1 is operatively connected to four 30 kW charging modules 2. The charging modules 2 may be any of the charging modules 70, 72 explained below with reference to FIGS. 5 to 9. A molded case circuit breaker (MCCB) 3 is provided to provide overload protection to the electrical circuit. A charger input contactor 4 is provided adjacent to an Earth leakage supervision relay 5. Two DC fuses 6 with respective DC contactors 7 provide output power for the connector 8. A battery (not shown) of a ground support equipment or vehicle can thus be charged via the connector 8.

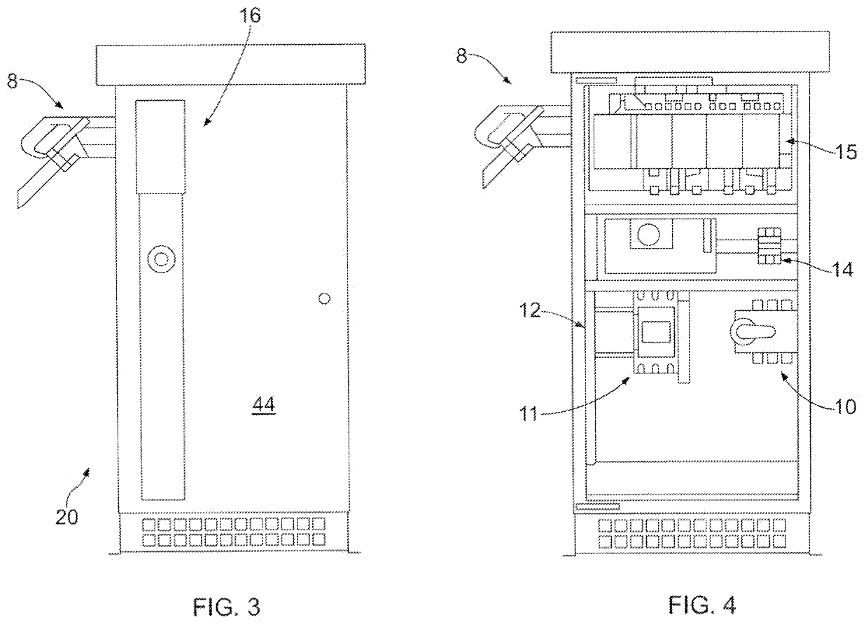

On a second side 44 of the cabinet 40, there is provided a ground power unit (GPU) section for powering the aircraft as shown in FIGS. 3 and 4. The second side 44 of the cabinet 40 has a user interface 16 for the GPU section. Within the cabinet 40, there is an input breaker 10, an output contactor 11 and an auxiliary power supply 12 for powering the aircraft. The auxiliary power supply 12 is connected to a miniature circuit breaker, MCB, 14. A control unit 13 provided within the cabinet 40 controls the operation of the GPU section. A converter part 15 is also provided for providing the output to the aircraft. The converter part 15 may be any of the solid state converters 60, 62 described below with reference to FIGS. 5 to 9.

The GPU section includes a solid state converter to control the power supplied to the battery charging unit. As the solid state converter has a pre-set maximum power that it can draw from the airport power source and can monitor the power drawn by the aircraft (if any), the solid state converter can determine how much of the airport power source is surplus to present requirement and divert excess power to the battery charging unit. This can be achieved, for example, based on a control signal that is indicative of the maximum power available for the battery charging unit based on the difference between the known maximum power of the airport power source and the instantaneous power drawn by the aircraft. This would provide near-instantaneous power management within the ground support equipment to ensure power to the aircraft is always prioritized and that the electrical circuit is not overloaded. This advantageously does not require a current transducer or a separate load sharing controller as in the prior art. The present ground support equipment 20 is therefore simpler in design as the controller of the solid state converter can be used to detect input current of the ground support equipment as a whole and generate a control signal based on the input current drawn by the solid state converter to determine any remaining power capacity of the airport power source. This control signal can then be transmitted or sent to the battery charging unit to control the amount of power drawn by the charging modules 2, for example from a DC bus 57 when present, as explained below.

In one example, the ground support equipment 20 is pre-fused by an external 200 A fuse in the feeder line of the ground support equipment 20, which corresponds to approximately 138 kW at 400V mains. In some cases, the GPU section is able to provide 90 kW of power. In the illustrated example, four 30 kW constant power charging modules 2 are used to generate a total of 120 kW. However, it would be apparent that other pre-determined maximum power levels, for example 180 kW, could be provided by using a different arrangement of charging modules 2.

The battery charging unit section is illustrated with charging modules 2 connected in parallel, which are powered from the airport power source, for example a 50/60 Hz AC power source. In some cases, it is possible to use DC/DC modules powered from a 400 Hz internal DC bus which provides an AC power output for the aircraft.

The control unit 13 is able to reduce the power consumption of the battery charging unit to avoid overloading the feeder circuit when there is a high power demand from the GPU section. As the aircraft rarely draws maximum power from the GPU section, there is typically capacity for charging battery-powered ground support equipment or vehicle while 400 Hz power is supplied to the aircraft when on the ground. The DC charging is combined with a GPU section in the present ground support equipment 20 to further utilize the existing electrical circuits that are present in GPUs. Specifically, a solid state converter which is able to monitor the power drawn by the aircraft and can control the amount of power that can be drawn by the charging modules 2.

FIGS. 5 to 9 are schematic illustrations of exemplary electrical circuits which are suitable for implementing the ground support equipment described above. FIG. 5 illustrates an electrical circuit within the cabinet 40 described above. The cabinet 40 has an input for an airport power source 50 and an output 64 for an aircraft 65 and a separate output 74 for DC charging a battery-powered ground support equipment 75, such as an electric vehicle in the manner described above. The input 50 is connected to a rectifier 55 which provides a DC bus 57 for a solid state converter 60. The solid state converter 60 has an in-built inverter which provides a suitable output 64 for the aircraft 65, for example 200V AC at 400 Hz. The input 50 is also connected to a battery charging unit 70 comprising a series of charging modules 70A-70D each having their own rectifier. The charging modules 70A-70D are connected in parallel and arranged to provide a X output 74 for charging as explained above. The controller of the solid state converter 60 is operatively connected to the battery charging unit 70 and is able to send a control signal 59 to the battery charging unit 70 in the manner described above.

FIG. 6 illustrates an alternative circuit where the rectifier 55 is connected to both the solid state converter 60 and the battery charging unit 72, where the battery charging unit comprises a parallel arrangement of charging modules 72A-72D. In the electrical circuit of FIG. 6, the arrangement of charging modules 72A-72D do not require an in-built rectifier, as the AC to DC conversion is provided by rectifier 55. In this example, the DC bus 57 is able to power the charging modules 72A-72D of the battery charging unit 72, the solid state converter 60 and any other components within the ground support equipment. The controller of the solid state converter 60 is operatively connected to the battery charging unit 72 and is able to send a control signal 59 to the battery charging unit 72 in the manner described above.

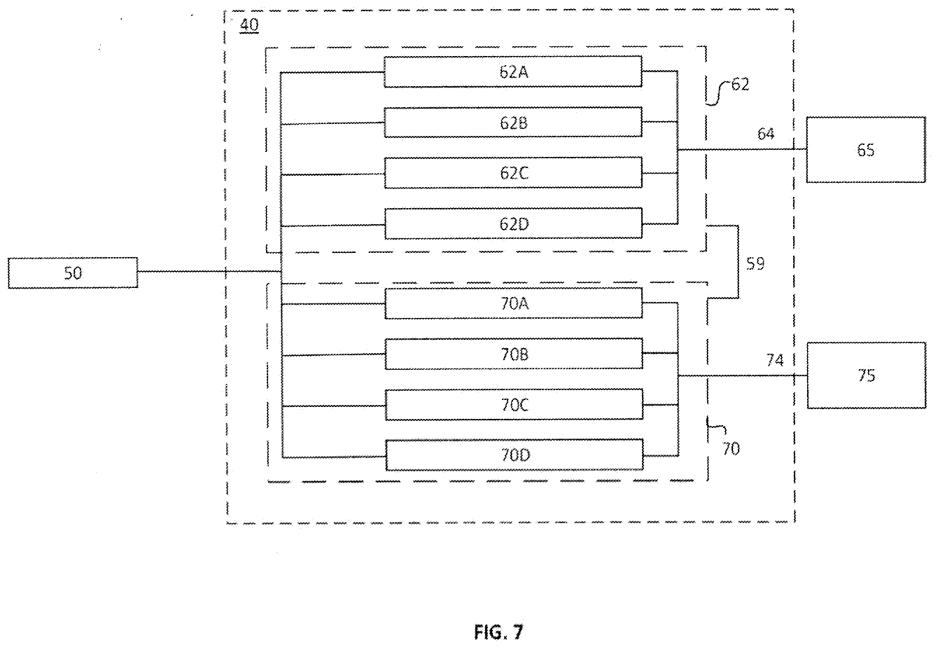

In some cases, the solid state converter and/or the charging modules can have their own in-built rectifier. This advantageously does away with the need to have a separate rectifier 55 to provide a DC bus 57 for powering the respective components. Similarly, it is possible to provide multiple smaller solid state converter modules rather than a single large component. This advantageously allows for the space within the cabinet 40 to be better utilized. FIG. 7 illustrate an example, where there is no separate rectifier and the single solid state converter has been replaced by smaller solid state converter modules 62A-62D each with an in-built rectifier. The airport power source 50 is connected to the parallel arrangement of solid state converter modules 62A-62D and also to the parallel arrangement of charging modules 70A-70D of the battery charging unit 70. Charging modules 70A-70D provide power for DC charging as explained above, while the solid state converter modules 62A-62D provide the output 64 for powering the aircraft 65 as explained above. It would be apparent the controller of any of the solid state converter modules 62A-62D could be used to provide the control signal 59 to the battery charging unit 70 in the manner described above.

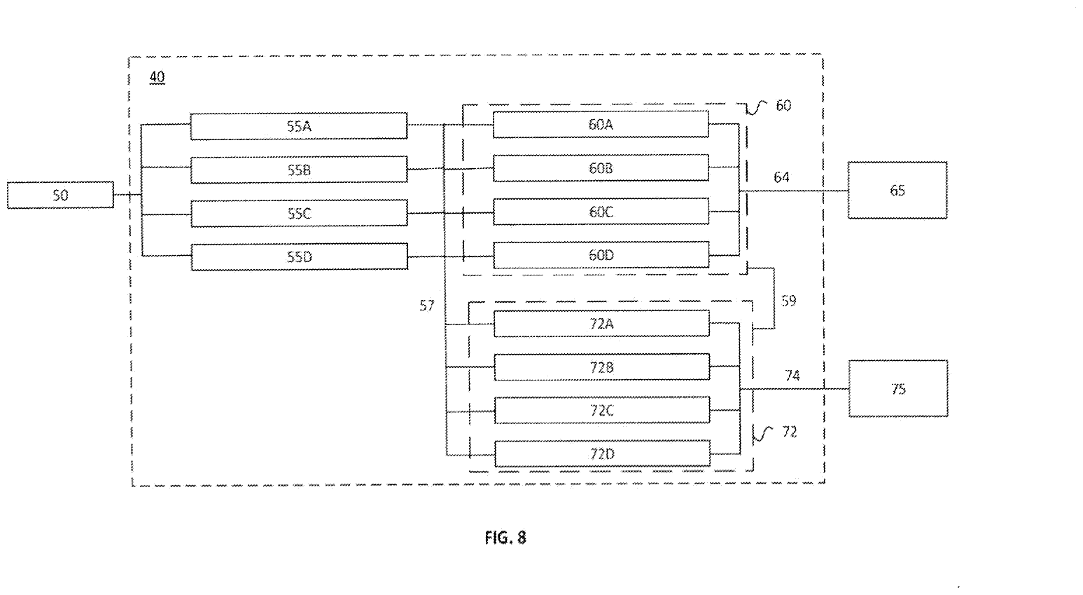

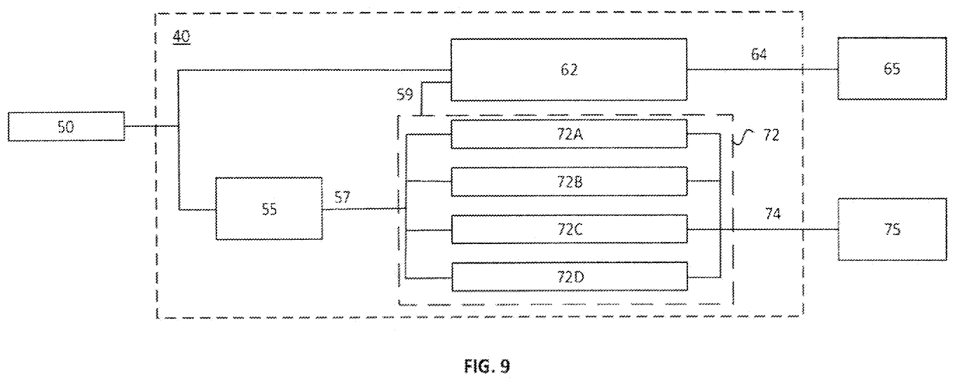

In some cases, the rectifier can be implemented as a series of smaller rectifier modules 55A-55D as shown in FIG. 8. This advantageously allows for the space within the cabinet 40 to be better utilized. The rectifier modules 55A-55D are connected in parallel and provide a DC bus 57 for power components within the cabinet 40. FIG. 8 illustrates a parallel arrangement of solid state converter modules 60A-60D for providing an output 64 for powering the aircraft 65. In this case, the functionality of a rectifier is separated from the solid state converter modules 60A-60D, so that solid state converter modules 60A-60D without an in-built rectifier can be used with the present ground support equipment. As with FIG. 6, the charging modules 72A-72D of the battery charging unit 72 also do not have an in-built rectifier. It would be apparent the controller of any of the solid state converter modules 62A-62D could be used to provide the control signal 59 to the battery charging unit 72 in the manner described above.

A further electrical circuit is shown in FIG. 9. The cabinet 40 includes an input for receiving the airport power source 50, and output ports 64, 74 for the aircraft 65 and the battery charger 75 respectively. In this circuit, a separate rectifier 55 is connected to the airport power source 50 and provides a DC bus 57 for powering the charging modules 72A-72D of the battery charging unit 72 independently of the solid state converter 62. In this case, a single solid state converter 62 is connected directly to the airport power source 50 and includes an in-built rectifier and inverter to provide the output 64 for the aircraft 65. The controller of the solid state converter 62 is operatively connected to the battery charging unit 72 and is able to send a control signal 59 to the battery charging unit 72 in the manner described above.

As will be appreciated by the exemplary circuits shown in FIG. 5 to 9, it is possible to use multiple smaller modules in place of a single larger solid state converter, rectifier and/or charging module, although this is not essential. Similarly, it is possible tor the solid state converter and/or the charging module(s) to include an in-built rectifier although this is not essential. In some cases, the inverter may be provided as a separate component to the solid state converter.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

It is claimed:

1. Ground support equipment for powering an aircraft on the ground, the ground support equipment comprising:
a solid state converter configured to power an aircraft on the ground from an airport power source having a pre-determined maximum power;
a battery charging unit configured to charge an external battery from the airport power source;
wherein the solid state converter is configured to measure an instantaneous power drawn by the aircraft; and
wherein the solid state converter is configured to generate a control signal for controlling the battery charging unit, the control signal being indicative of a maximum power available for the battery charging unit based on the difference between the pre-determined maximum power of the airport power source and the instantaneous power drawn by the aircraft.

2. The ground support equipment according to claim 1, wherein the solid state converter is configured to receive a user input for setting the pre-determined maximum power.

3. The ground support equipment according to claim 1, wherein the battery charging unit comprises a plurality of charging modules configured to receive power from the airport power source.

4. The ground support equipment according to claim 3, wherein the plurality of charging modules are connected in parallel.

5. The ground support equipment according to claim 2, wherein at least one of the plurality of charging modules are configured to provide a 30 kW output.

6. The ground support equipment according to claim 3, wherein at least one of the plurality of charging modules is configured to convert an AC input to a DC output.

7. The ground support equipment according to claim 3, comprising a common rectifier configured to convert an AC input to a DC output to provide a DC bus for providing power to the battery charging unit.

8. The ground support equipment according to claim 7, wherein the DC bus is configured to provide power to each of the plurality of charging modules.

9. The ground support equipment according to claim 1, wherein the solid state converter is configured to provide a 400 Hz output.

10. The ground support equipment according to claim 1, wherein the solid state converter is configured to receive power from an AC power source.

11. The ground support equipment according to claim 1, wherein the solid state converter is configured to provide up to 180 kW output power.

12. The ground support equipment according to claim 1, wherein the battery charging unit is configured to provide an output power of 120 kW.

13. The ground support equipment according to claim 1, wherein the battery charging unit is configured to provide a DC power output.

14. The ground support equipment according to claim 1, comprising a plurality of solid state converters configured to provide power to the aircraft.

15. The ground support equipment according to claim 14, wherein the plurality of solid state converters are connected in parallel.
